(19) United States
(12) Patent Application Publication
(10) Pub. No.: US 2010/0077437 A1
(43) Pub. Date: Mar. 25, 2010

(54) Vehicle entertainment system with video surround

(75) Inventors: Michael McManus, Oakdale, PA (US); Joseph Ballay, Pittsburgh, PA (US); Jeremy Koempel, Pittsburgh, PA (US)

Correspondence Address: PANASONIC AUTOMOTIVE SYSTEM;COMPANY OF AMERICA, 776 HWY 74 SOUTH, PEACHTREE CITY, GA, 30269, US

(73) Assignee: Panasonic Automotive Systems Company of America, Division of Panasonic Corporation of North America, Peachtree City, GA (US)

(21) Appl. No.: 12/284,759

(22) Filed: Sep. 25, 2008

(51) Int. Cl. H04N 7/18

(52) U.S. Cl. 725/75; 348/159; 348/E07.085

(57) ABSTRACT

A vehicle entertainment system includes an image capture system, an image processing and storage system, and a user interface. The image capture system includes at least one interior camera adapted and positioned to capture images of at least one location within the vehicle. The image processing and storage system is electronically coupled to the image capture system and includes an image processor and a memory unit. The image processor receives and formats the images, while the memory unit stores the images. The interface system is electronically coupled to the image processing and storage system and includes a display unit, a user interface and a wireless communication unit. The display unit displays a plurality of the interior and exterior images. The user interface is engageable by a user to select the images displayed on the display unit and to direct the storage of the selected images in the memory unit.

### BACKGROUND OF THE INVENTION

1. Field of the Invention

The present invention relates to vehicle entertainment systems, and, more particularly, systems for capturing images in and/or around the vehicle.

2. Description of the Related Art

It is not unusual for family and friends to spend a substantial amount of their time together in a vehicle traveling from one place to another. A significant amount of the time parents spend with their children is spent traveling in a vehicle to and from daycare, school, social events, extracurricular sporting events, doctors' appointments, church, grocery stores and other destinations. In addition, many families chose their vehicle as a mode of transportation for vacation trips, resulting in even more family time in the vehicle. During this time, events occur that a person may want to memorialize either by video or photograph. To do this, passengers must use handheld cameras or phones.

However, handheld cameras and phones are often not equipped with the wide angle capability needed to capture images of passengers within the vehicle. Also, obstacles such as windshield wipers, windows and support beams make it difficult to capture images outside of the vehicle. In addition, it is very difficult for a driver of a vehicle to capture images of events occurring in and around the car, as the driver is occupied with operating the vehicle. Furthermore, oftentimes the event is spontaneous and unexpected. In this case, the event passes before a person has an opportunity to capture it with a camera or phone.

Accordingly, a need exists for a system for capturing images of events occurring in and around a vehicle, while the vehicle is being operated.

### SUMMARY

The present invention provides an entertainment system for capturing images in and/or around the vehicle. The entertainment system of the present invention captures images of locations or scenes within the vehicle cabin and/or exterior to the vehicle, arranges the images for viewing by the user, and saves the video images. The system captures images using a plurality of cameras, which are electronically coupled to a display unit. The display unit displays the captured images in real time. The system includes a user interface that allows the user to select the camera views displayed on the display unit. The system includes a memory unit that saves and stores the images captured by the cameras. The user interface also allows the user to initiate the saving of the images to the memory unit. The system may also include a wireless communication unit to allow the user to download the saved images from a remote location.

In one aspect of the invention, the entertainment system is adapted for use in a vehicle having an interior cabin, at least one front passenger seat disposed within the interior cabin, and at least one rear passenger seat disposed within the interior cabin. The entertainment system includes a plurality of cameras adapted and positioned to capture images of a plurality of locations within the interior cabin. An image processor is electronically coupled to the plurality of cameras and receives the images. A memory unit is electronically coupled to the image processor and is adapted to store the images. A display unit is electronically coupled to the processor and is adapted to simultaneously display a plurality of the images. The entertainment system also includes a user interface electronically coupled to the memory unit and the display unit. The user interface is engageable by a user to select the images displayed on the display unit and to select and direct the storage of the images in the memory unit.

In another aspect of the invention, the entertainment system is adapted for use in a vehicle having an interior cabin. The entertainment system includes an image capture system, an image processing and storage system, and an interface system. The image capture system includes at least one interior camera adapted and positioned to capture images of at least one location within the interior cabin. The image processing and storage system is electronically coupled to the image capture system and includes an image processor and a memory unit. The image processor receives and formats the images and the memory unit stores the images. The interface system is electronically coupled to the image processing and storage system and includes a display unit, a user interface and a wireless communication unit. The display unit displays a plurality of the images. The user interface is engageable by a user to select the images displayed on the display unit and to direct the storage of the selected images in the memory unit. The wireless communication unit is adapted to communicate with a remote location.

In still another aspect, the entertainment system is for use in a vehicle having an interior cabin. The entertainment system includes an image capture system, an image processing and storage system, and an interface system. The image capture system includes at least one interior camera and at least one exterior camera. The at least one interior camera is adapted and positioned to capture interior images of at least one interior location within the interior cabin. The at least one exterior camera is adapted and positioned to capture exterior images of at least one exterior location exterior to the vehicle. The image processing and storage system is electronically coupled to the image capture system. The image processing and storage system includes an image processor and a memory unit. The image processor receives and formats the interior and exterior images, while the memory unit stores the interior and exterior images. The interface system is electronically coupled to the image processing and storage system and includes a display unit, a user interface and a wireless communication unit. The display unit displays a plurality of the interior and exterior images. The user interface is engageable by a user to select the images displayed on the display unit and to direct the storage of the selected images in the memory unit. The wireless communication unit is adapted to allow a user at a location remote from the vehicle to select the images, direct the storage of the selected images in the memory unit, download the selected images, and view the selected images.

An advantage of the entertainment system of the present invention is that it allows the user to more clearly visualize, monitor and communicate with the vehicle passengers.

Another advantage is that the entertainment system also allows the user to memorialize events occurring in and around the vehicle.

The entertainment system of the present invention also allows the user to download images of memorialized events to remote devices.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic drawing of a vehicle having an entertainment system in accordance with one embodiment of the present invention;

FIG. 2 is a schematic drawing of a display unit of an entertainment system in accordance with one embodiment of the present invention;

FIG. 2A illustrates the Add/Select Display drop down menu of the display unit of FIG. 2;

FIG. 3 is a flow chart illustrating one operation of an entertainment system in accordance with an embodiment of the present invention;

FIG. 4 is a flow chart illustrating another operation of an entertainment system in accordance with an embodiment of the present invention; and

FIG. 5 is a flow chart illustrating another operation of an entertainment system in accordance with an embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

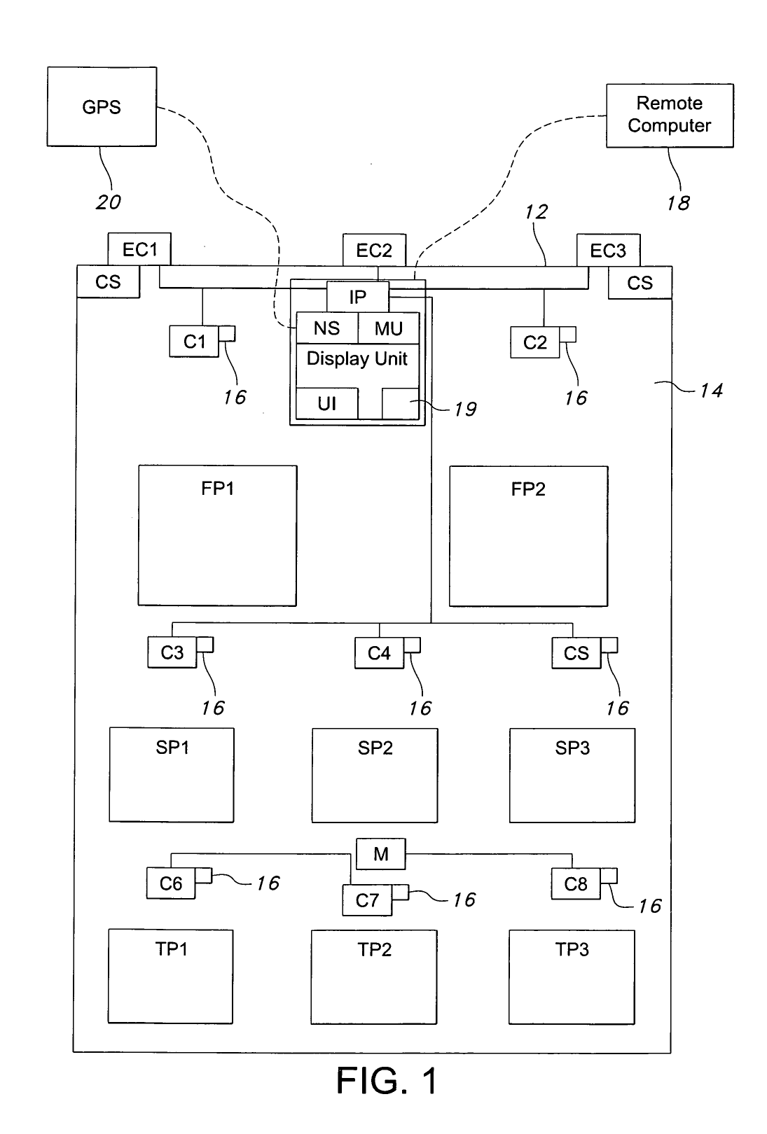

Referring first to FIG. 1, an entertainment system for use in vehicle 12, according to one embodiment of the present invention, is illustrated. Vehicle 12 may be any passenger vehicle including a car, sport utility vehicle, van or other passenger vehicle. Vehicle 12 includes interior cabin 14, in which is disposed first and second front passenger seats FP1, FP2; first, second and third second-row passenger seats SP1, SP2, SP3; and first, second and third third-row passenger seats TP1, TP2, TP3.

The entertainment system installed in vehicle 12 generally includes an image capture system, an image processing and storage system and an interface system. The image capture system includes a plurality of interior cameras C1-C8 disposed within interior cabin 14 and adapted to capture images of various locations within interior cabin 14. For instance, interior cameras C1-C8 are arranged in association with each of seats FP1-2, SP1-3 and TP1-3, such that cameras C1-C8 capture images of the passengers in each of these seats. It should be understood that the image capture system need not include one camera for each seat. Rather, one camera could be configured to capture images of multiple passengers, such as by the use of a wide angle lens, or by directing the camera at an angle across cabin 14.

Referring still to FIG. 1, the image capture system may also include exterior cameras EC1, EC2, EC3, which may be disposed either inside or outside of vehicle 12 and are adapted to capture images of the area outside of vehicle 12. For example, exterior camera EC1 may be configured to capture images of the area in front of the driver-side corner of the vehicle bumper, while exterior cameras EC2, EC3 capture images of the area in front of the middle section and passenger-side corner, respectively, of the vehicle bumper. Exterior cameras EC1, EC2, EC3 may be configured to capture images in close range, such as a few feet, or long range, such as ten or more feet. For instance, exterior camera EC1 may be adapted to capture long range images that include other cars and intersections. Exterior camera EC2 may be adapted to capture shorter range images such as nearby curbs and walls.

The image capture system may also include light level sensors 16. Light level sensors 16 are adapted to sense the level of light within interior cabin 14 and adjust interior cameras C1-C8 accordingly. Microphone M may also be installed to capture sounds in interior cabin 14 simultaneously, and in correspondence, with the capturing of images by cameras C1-C8. That is, each portion of the captured sounds may be identified with a respective frame or set of frames of the video images such that the corresponding sounds may be retrieved along with any retrieved video image.

Still referring to FIG. 1, the image processing and storage system generally includes image processor IP and memory unit MU. Image processor IP is electronically coupled to interior and exterior cameras C1-C8, EC1-EC3. Image processor IP is adapted to receive images captured by interior and exterior cameras C1-C8, EC1-EC3 and process the images to achieve a format that may be viewed on a display unit, which is discussed in further detail below. Image processor IP may be any processing hardware and software used to process and display images captured by a camera.

The image processing and storage system also includes memory unit MU, which is adapted to store saved images captured by interior and exterior cameras C1-C8, EC1-EC3. Memory unit MU may be configured to automatically save images and store the saved images for a pre-determined amount of time. Alternatively, memory unit MU may be configured to save images only upon receiving an affirmative command from the user. In still another alternative, memory unit MU may be configured to both automatically save images and store images for a predetermined time period, and to save images for a longer period of time after receiving a command from the user. Memory unit MU may be in the form of one or more devices capable of storing information, such as a hard drive, disc, memory stick, flash memory card, USB memory device or other portable, removable or stationary memory device. Various configurations and operations of memory unit MU are discussed in further detail below.

Referring still to FIG. 1, an interface system is electronically coupled to the image processing and storage system, and includes the display unit and user interface UI. The display unit may be in the form of a video monitor, such as that used in an on-board navigational system provided in vehicle 12 and, in fact, may be the video monitor of the on-board navigational system. User interface UI is configured to receive commands and/or data from the user and transmit those commands to the image processing and storage system. User interface UI may be in the form of any device capable of receiving and transmitting user commands. For instance, user interface UI may be in the form of a keyboard or touch screen. In one embodiment, user interface UI is incorporated into the display unit, in which case display unit/user interface UI is a video touch-screen monitor capable of displaying images and touch buttons, and receiving user input via the touch buttons.

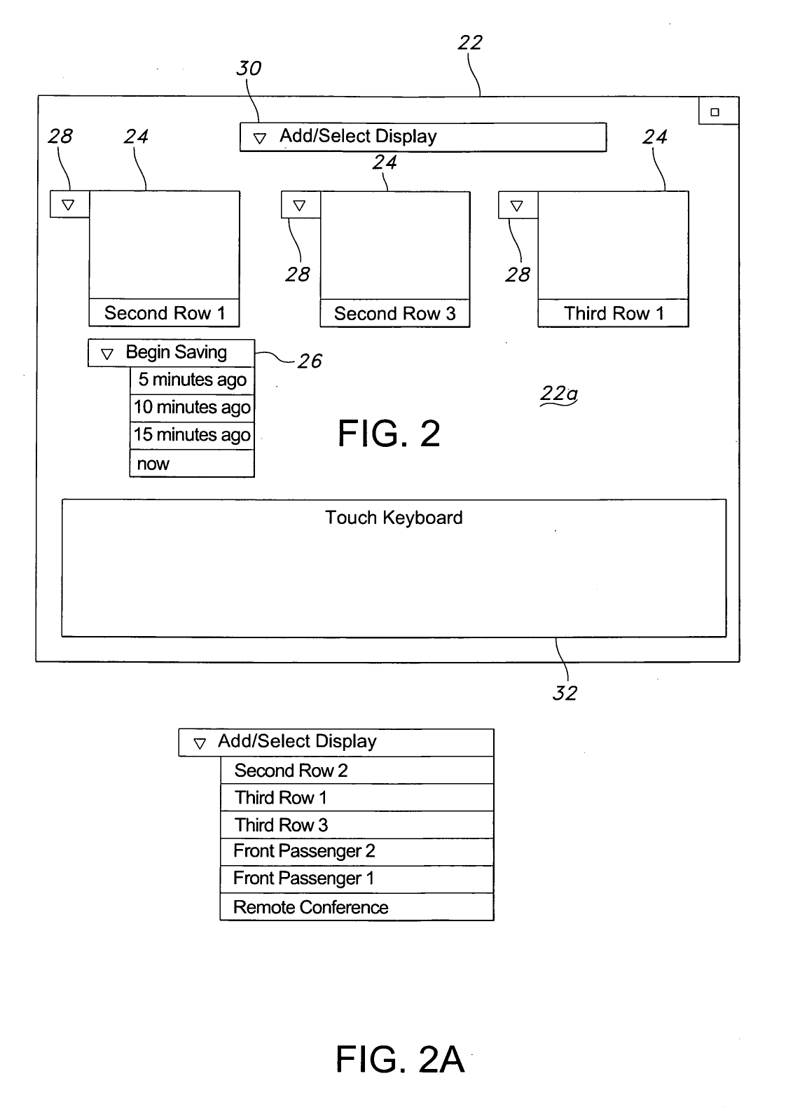

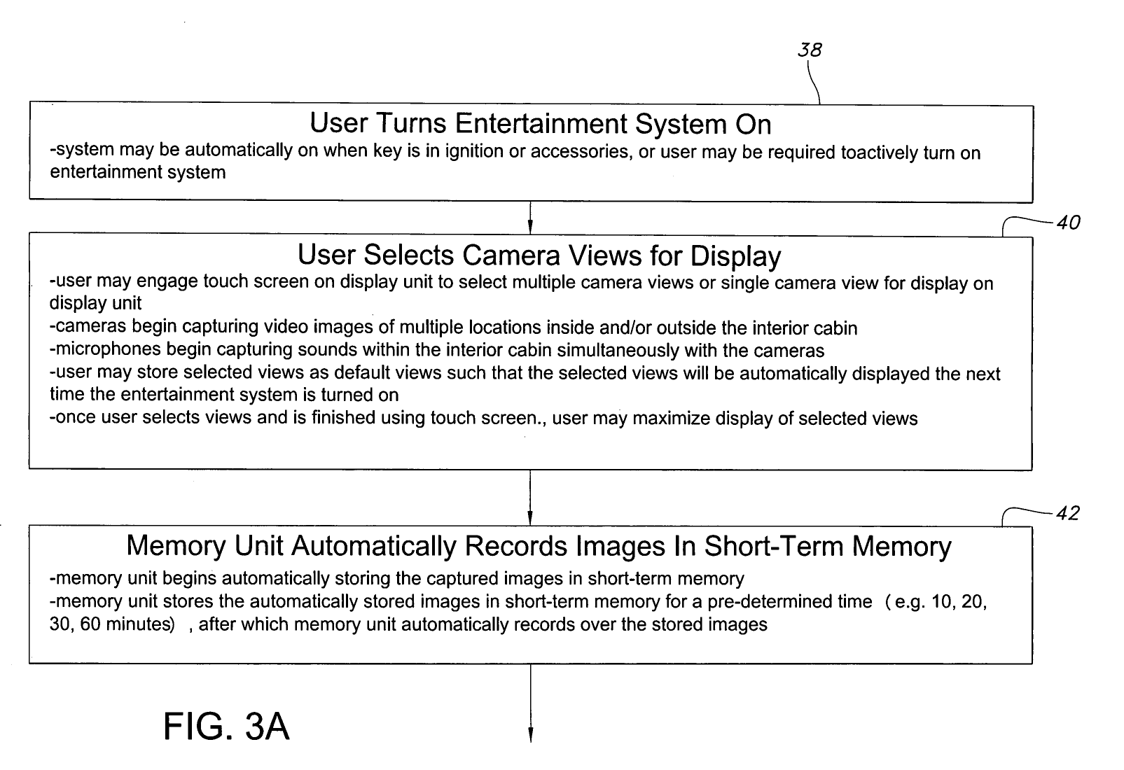

Turning to FIG. 2, an example of display unit 22 with incorporated user interface is illustrated. Display unit 22 includes screen 22a on which may be projected a plurality of image displays 24. Each of image displays 24 corresponds to the images captured by one of cameras C1-C8, EC1-EC3 (FIG. 1). Display unit 22 may include a plurality of drop down menu buttons 26, 28, 30, which may be engaged by the user by touching screen 22a in the area of menu buttons 26, 28, 30. Touch keyboard 32 may also be displayed on screen 22a. Touch keyboard 32 may include all the keys (not shown) typically found in a standard keyboard and may be engaged by the user by touching screen 22a.

Referring still to FIG. 1, the interface system may also include wireless communication unit 19 capable of communicating with a source that is remote from vehicle 12, such as remote computer 18. Wireless communication unit 19 may be a satellite receiver, cell phone or other wireless communication device.

As shown in FIG. 1, vehicle 12 may also be equipped with navigational system NS, which may be in communication with global positioning satellites GPS to receive vehicle location, date, time, geographic/mapping and other information. Navigational system NS may be electronically coupled to the image processing and storage system to thereby allow additional data to be stored in correspondence with the video images. That is, each portion of the navigation data may be identified with a respective frame or set of frames of the video images such that the corresponding navigation data may be retrieved along with any retrieved video image. Vehicle 12 may also include collision sensors CS electronically coupled to the image processing and storage system and adapted to sense when vehicle 12 has experienced a collision.

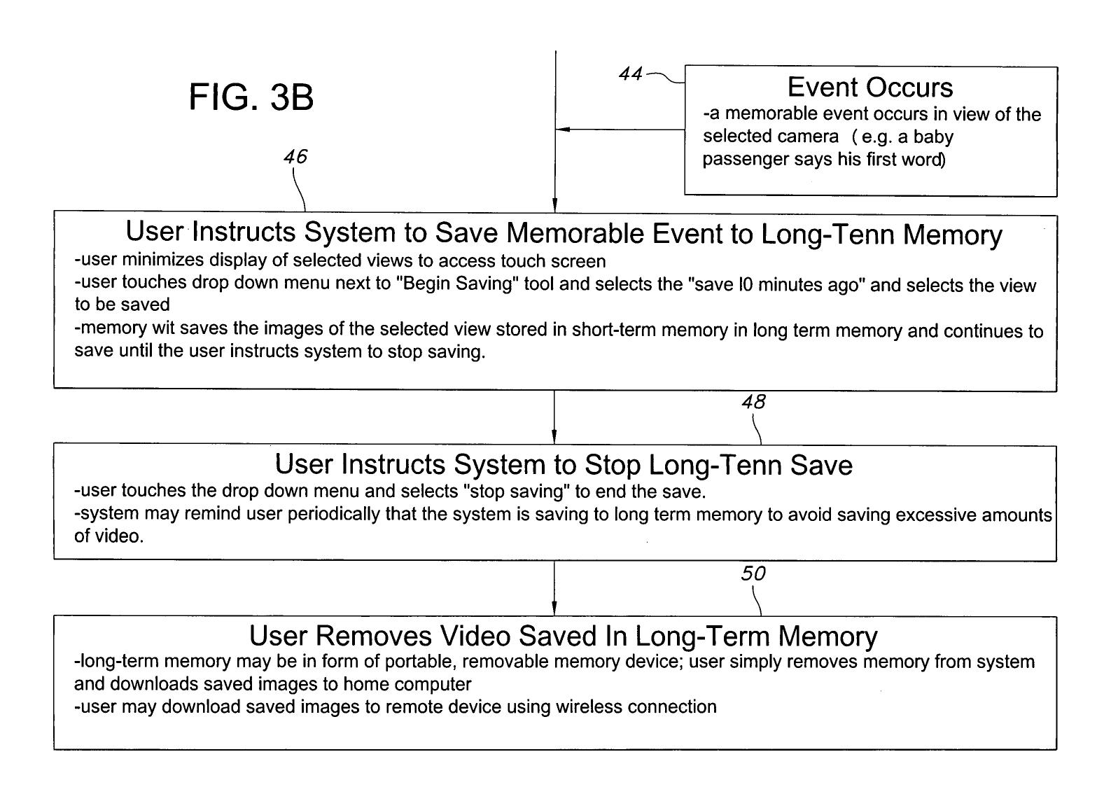

Turning now to FIGS. 2, 2A and 3, operation of the entertainment system, according to one embodiment of the present invention, will now be described. FIG. 3 is a diagram illustrating the steps for operating the entertainment system in accordance with one embodiment of the present invention. First, the entertainment system is turned on (38) (FIG. 3). The entertainment system of the present invention may be powered by any known means, including the vehicle battery (not shown) or a separate rechargeable battery devoted to the entertainment system. The entertainment system may be adapted to turn ON automatically when the vehicle key is in the ignition and/or accessories position. Alternatively, the entertainment system may be configured such that the user may be required to actively engage an ON switch (not shown), which may be incorporated into the user interface.

Once the entertainment system is turned on (38), the user then selects the camera views/images for display (40) on screen 22a. In the embodiment shown in FIG. 2, the user may select the images by touching drop down menu button 30, which causes the menu illustrated in FIG. 2A to appear on screen 22a. The user may then select the image desired. After selecting the image, the image appears on screen 22a as one of displays 24. Cameras C1-C8, EC1-EC3 and microphone M (FIG. 1) may be adapted to begin capturing images and sounds automatically when the entertainment system is turned on. Accordingly, when the user selects the camera views, the images captured by the corresponding camera appear on display 22 as cameras C1-C8, EC1-EC3 capture the images. The interface system may also be configured to allow the user to select default views that will be displayed automatically each time the system is turned on. By viewing the selected image displays 24 on screen 22a, the user can better monitor the vehicle passengers. Display unit 22 may be equipped with a microphone and speaker for video teleconferencing with the vehicle passengers, thus improving communication between vehicle occupants. In addition to the images captured by cameras C1-C8, EC1-EC3, the user may elect to video conference with someone from a remote location. In this case, the user would select “Remote Conference” from the menu shown in FIG. 2A. By making this selection, the system would prompt the user for the contact information (phone number, IP address) for the remote participant.

As illustrated in step (42) of FIG. 3, memory unit MU begins to store captured images automatically when the system is turned on. Although FIG. 3 depicts this step (42) as occurring after user selects camera views for display (40), this step may actually occur the moment the entertainment system is turned on and may be occurring during step (40). As previously discussed, memory unit MU (FIG. 1) may include one or more memory devices. For instance, memory unit MU may include a long term memory device and a short term memory device, both of which may be in the form of any device that is capable of storing video images. For example, either of the long term memory and the short term memory may include a hard drive, disk, memory stick, flash memory card, or USB memory device. Memory unit MU automatically stores video images captured by the cameras in the short term memory device. Memory unit MU may be configured to store the images in the short term memory for a pre-set amount of time, after which memory unit will begin storing new images over, i.e., overwriting, the saved images.

Referring still to FIG. 3, when an event occurs (44) that the user wants to memorialize, the user can instruct memory unit MU to save the memorable event to long-term memory (46). For instance, if a baby passenger speaks his first words while riding in the vehicle, or a child passenger says something amusing, the user might want to memorialize this event by saving the video footage of the event. The user may touch drop down menu button 26 and select the start time for the long-term save. If the event occurred 5-7 minutes ago, the user might select the “10 minutes ago” option. The user may then select the image view to be saved by touching the corresponding display 24 on which the event was displayed. Memory unit then stores the images saved in short-term storage in the long-term storage and appends to those images until the user instructs the memory unit to stop saving (48). The user may stop the long-term save by engaging a stop save button (not shown) on touch screen 22a. Button 26 may be configured to change to a stop button after user begins the save. In this case, the user would stop saving by engaging button 26. The user may also annotate the images by entering data using touch keyboard 32 (FIG. 2), providing sound/vocal annotation using microphone M, and/or by including information received from the navigational system NS (FIG. 2). This system allows a user to capture memorable events occurring inside and outside of the vehicle.

The user may then remove video images stored in long-term memory (50). As already noted, long-term memory may be in the form of a portable, removable memory device such as a disk, USB memory device, memory stick or flash card. In this case, the user may extract the saved images from memory unit MU by removing the long-term memory and connecting the long-term memory to a computer to download the saved images. Alternatively, the user may access, and download, the images in the long-term memory device by using a remote computer via a wireless communication line. The remote computer may communicate with wireless communication unit 19 (FIG. 1).

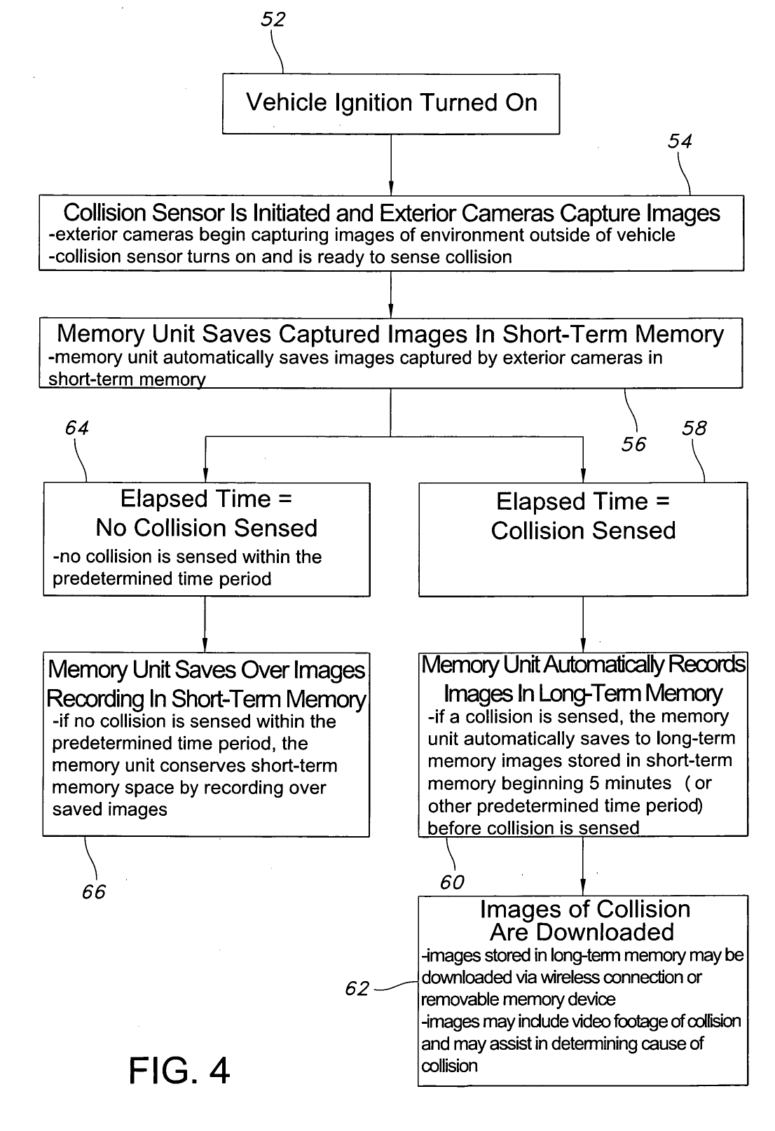

Turning now to FIG. 4 another useful operation of a system of the present invention will now be described. A system of the present invention may also be useful in capturing events leading up to and contributing to a vehicle collision. As illustrated in FIG. 4, the vehicle ignition is turned on (52). The system may be configured such that once the vehicle ignition is turned on (52), collision sensors CS (FIG. 1) are automatically initiated and exterior cameras EC1-EC3 begin capturing images automatically (54). Memory unit MU saves the captured images automatically in short-term memory (56). If a collision is sensed by collision sensors CS (FIG. 1), collision sensors CS communicate a signal to the memory unit. After a predetermined elapsed time, if no collision is sensed and no collision signal is received by memory unit MU from collision sensors CS (64), memory unit conserves short-term memory space by saving, i.e., overwriting, new images over saved images (66). Conversely, if collision sensor CS senses a collision during the predetermined elapsed time (58), collision sensors CS send a collision signal to the memory unit. In response to this signal, the memory unit automatically saves the images stored in short-term memory in long-term memory for the period beginning five minutes (or other pre-set time) prior to the sensed collision (60). Thus, the collision sensor directs the memory unit to permanently save the saved exterior images corresponding to the sensed collision in correspondence with the sensed collision. The images of the collision may be removed from long-term memory (62), as discussed above. That is, the images may be downloaded to a remote computer via wireless connection with wireless communication unit 19. Alternatively, the long-term memory may be in the form of a removable storage medium that may be removed from the system and coupled to a remote computer. These saved images may assist in determining the cause of the collision.

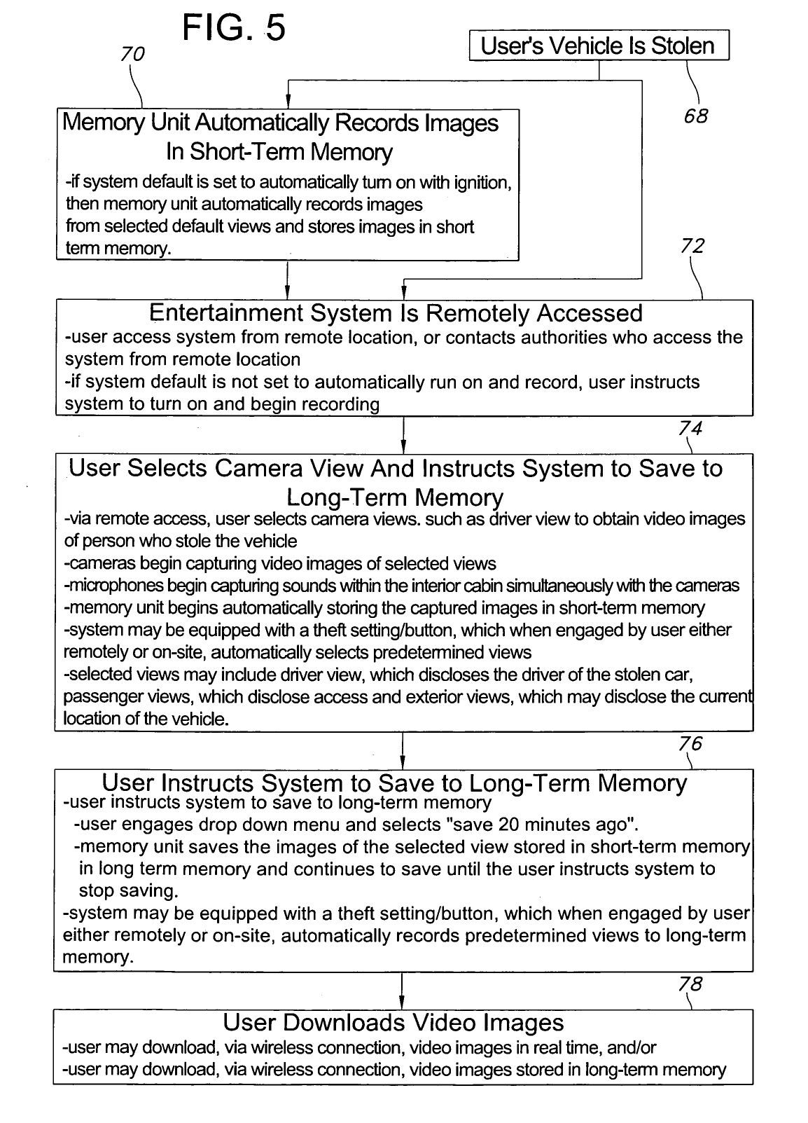

Turning to FIG. 5, yet another useful operation of a system according to the present invention will now be described. As illustrated in FIG. 5, a system of the present invention may also be of assistance in the unfortunate event of the vehicle being stolen (68). If the system is configured to begin recording images automatically when the vehicle ignition is turned on, then memory unit MU begins recording images in short-term memory (70) including images of the driver obtained from camera C1. Images obtained from cameras EC1-EC3 may also be helpful in recording the location and travel path of the vehicle, while cameras C2-C8 may record accomplices seated in passenger seats FP1, FP2, SP1-SP3, and TP1-TP3. The system may then be accessed remotely (72) while the theft is taking place (i.e., while the culprit is driving the vehicle). The user accesses the interface system via a wireless link to wireless communication unit 19 (FIG. 1). Via this remote access, the user can control the system and instruct the system. For instance, if the system does not turn on automatically, user can turn the system ON (74). The user can select the camera views (74) and initiate the storing of images to long-term storage (76).

The system may be equipped with a theft button or other vehicle security system feature to more quickly initiate the long-term storage of relevant images. The theft button may be pre-programmed to instruct the user interface system and memory unit to select certain camera views and record images to long-term storage. The theft-button may be engaged either on-board the vehicle or remotely. The theft button may also be pre-programmed to initiate communication between the navigational system NS (FIG. 1) and the memory unit MU to cause the vehicle location and travel path to be recorded. Via wireless communication unit 19, a user may also receive information from the navigational system NS (FIG. 1) to determine the location of the vehicle. The user may download the video images (78) in real time (as they are captured) via the wireless connection, or may download the images stored in long-term memory as described above.

The cameras of the present invention may also be used to monitor the vehicle before a theft has occurred. When a user enters the vehicle, unless he enters a security code or otherwise validates that he is an approved user, the captured video may be automatically stored in long term memory or transmitted to a remote location. Further, navigational data may also be transmitted to a remote location so that the vehicle may be found by police.

It is also possible, within the scope of the invention, for noise/sound or motion sensors to be used to trigger the capturing or saving of video images, or the transmission of video images to a remote location. Such noise/sound or motion sensors may be integrated into collision sensors CS and/or into light level sensors 16.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An entertainment system for use in a vehicle having an interior cabin, at least one front passenger seat disposed within the interior cabin and at least one rear passenger seat disposed within the interior cabin, said entertainment system comprising:
a plurality of cameras adapted and positioned to capture images of a plurality of locations within the interior cabin;
an image processor electronically coupled to said plurality of cameras and receiving said images;
a memory unit electronically coupled to said image processor and adapted to store said images;
a display unit electronically coupled to said processor and adapted to simultaneously display a plurality of said images; and
a user interface electronically coupled to said memory unit and said display unit, said user interface engageable by a user to select said images displayed on said display unit and to select and direct the storage of said images in said memory unit.

2. The entertainment system of claim 1 wherein at least one of said plurality of locations is the at least one rear passenger seat.

3. The entertainment system of claim 1 wherein at least one of said plurality of locations is the at least one front passenger seat.

4. The entertainment system of claim 1 wherein at least one of said plurality of cameras includes a wide angle lens.

5. The entertainment system of claim 1 further comprising light level sensors electronically coupled to said plurality of cameras, said light level sensors being configured to sense a level of light in said plurality of locations and adjust said plurality of cameras according to the sensed level of light.

6. The entertainment system of claim 1 wherein said images are in the form of motion video.

7. The entertainment system of claim 1 further including a navigational system electronically coupled to said image processor, said navigational system receiving data regarding a vehicle condition, said memory unit storing said data in correspondence with said images.

8. The entertainment system of claim 7 wherein said data includes vehicle location.

9. The entertainment system of claim 7 wherein said data includes at least one of a date and time.

10. The entertainment system of claim 1 further comprising a wireless communication unit coupled to said memory unit, said wireless communication unit receiving communications from a remote location, said wireless communication unit adapted to initiate the storage of said images in response to said communications.

11. The entertainment system of claim 1 further comprising a wireless communication unit coupled to said memory unit, said wireless communication unit configured to receive communications from a remote location, said wireless communication unit adapted to download said images stored in said memory unit to said remote location.

12. The entertainment system of claim 1 wherein said user interface includes a touch screen in said display unit.

13. The entertainment system of claim 12 wherein said touch screen includes a keyboard configured to enable said user to textually annotate said images stored in said memory unit.

14. The entertainment system of claim 1 further including at least one microphone electronically coupled to said memory unit, said microphone configured to capture sounds in the interior cabin simultaneously with said images, said memory unit storing said sounds in correspondence with said images.

15. The entertainment system of claim 1 wherein said memory unit includes an auto save feature configured to direct said memory unit to automatically save said images.

16. The entertainment system of claim 15 wherein said memory unit includes an auto discard feature configured to direct said memory unit to automatically discard said saved images after a set period of time.

17. The entertainment system of claim 16 further comprising at least one exterior camera positioned to capture exterior images of an area exterior to the vehicle.

18. The entertainment system of claim 17 further including a collision sensor coupled to said memory unit, said collision sensor configured to sense a vehicle collision and direct said memory unit to permanently save said saved exterior images corresponding to the collision.

19. The vehicle entertainment system of claim 1 wherein said image processor is electronically coupled to said plurality of cameras by wireless connection.

20. The vehicle entertainment system of claim 1 wherein said memory unit is a removable, portable memory device.

21. An entertainment system for use in a vehicle having an interior cabin, said entertainment system comprising:
an image capture system including at least one interior camera adapted and positioned to capture images of at least one location within the interior cabin;
an image processing and storage system electronically coupled to said image capture system, said image processing and storage system including an image processor and a memory unit, said image processor configured to receive and format said images, said memory unit configured to store said images; and
an interface system electronically coupled to said image processing and storage system and including a display unit, a user interface and a wireless communication unit, said display unit displaying a plurality of said images, said user interface engageable by a user to select said images displayed on said display unit and to direct the storage of said selected images in said memory unit, said wireless communication unit adapted to communicate with a remote location.

22. The entertainment system of claim 21 wherein said memory unit includes a short term memory module and a long term memory module.

23. The entertainment system of claim 22 wherein said image processing and storage system includes an auto save feature and an auto discard feature, said auto save feature configured to direct said memory unit to automatically save said images in said short term memory module, said auto discard feature configured to direct said memory unit to automatically discard said images saved in said short term memory module after a set period of time.

24. An entertainment system for use in a vehicle having an interior cabin, said entertainment system comprising:
an image capture system including at least one interior camera and at least one exterior camera, said at least one interior camera adapted and positioned to capture interior images of at least one interior location within the interior cabin, said at least one exterior camera adapted and positioned to capture exterior images of at least one exterior location exterior to the vehicle;
an image processing and storage system electronically coupled to said image capture system, said image processing and storage system including an image processor and a memory unit, said image processor configured to receive and format said interior and exterior images, said memory unit configured to store said interior and exterior images; and
an interface system electronically coupled to said image processing and storage system and including a display unit, a user interface and a wireless communication unit, said display unit configured to display a plurality of said interior and exterior images, said user interface engageable by a user to select said images displayed on said display unit and to direct the storage of said selected images in said memory unit, said wireless communication unit adapted to allow a user at a location remote from the vehicle to select said images, direct the storage of said selected images in said memory unit, download said selected images, and view said selected images.
